(19) United States
(12) Patent Application Publication
(10) Pub. No.: US 2013/0032130 A1
(43) Pub. Date: Feb. 7, 2013

(54) USER ADJUSTABLE COUPLING DEVICE OR HINGE

(71) Applicants: David A. Jacques, Delano, MN (US); Mark L. Jacques, Cologne, MN (US); Mark D. McMullen, Mounds View, MN (US)

(72) Inventors: David A. Jacques, Delano, MN (US); Mark L. Jacques, Cologne, MN (US); Mark D. McMullen, Mounds View, MN (US)

(21) Appl. No.: 13/195,803

(22) Filed: Aug. 1, 2011

(51) Int. Cl. A47J 33/00; F16C 11/04

(52) U.S. Cl. 126/30; 248/218.4

(57) ABSTRACT

A user adjustable coupling device or hinge adapted to be attachable to a spine is disclosed. The device or hinge comprises a curved, hook end on a horizontally oriented upper bracket, a vertically oriented support brace, and a curved, oval-shaped end on a horizontally oriented lower bracket that gives the hinge a C-shaped configuration. The hook and oval ends allow the hinge to be quickly and easily attached and removed from the spine without the use of tools. The coupling device or hinge may be utilized in an outdoor cooking apparatus. The apparatus comprises an enclosed area defining a heat containment structure, a spine operably connected to the heat containment structure, a collar operably connected to the spine, and at least one cooking support attached or attachable to the coupling device or hinge.

### BACKGROUND OF THE INVENTION

1. Field of the Invention

The present invention relates to a coupling device or hinge that provides quick and simple connection and disconnection to and from a spine, user adjustable positioning of the device or hinge along a length of the spine, wide-angle rotatable movement of the device or hinge around an axis of the spine, and quick and simple connection and disconnection of a component to the coupling device or hinge.

2. Description of the Prior Art

Coupling devices or hinges are well known and many types exist in the prior art. Most types, however, solve limited, narrow problems that do not readily adapt to other purposes. For example, U.S. Pat. No. 1,145,759 to Dwyer discloses a hinge for use on storm doors, windows, or ordinary doors with a removable pintle. U.S. Pat. No. 3,059,271 to Ericsson discloses a hinge for supporting a door on a frame to swing about a fixed axis between open and closed positions to permit easy removal of the door from the frame.

Similarly limited is U.S. Pat. No. 2,588,271 to Morgan that discloses a disconnectable hinge for parking meter doors. U.S. Pat. No. 2,926,382 to Knese et al. discloses a quick-release hinge with a pintle for chassis arrangements of complex electronic equipment. U.S. Pat. No. 4,187,050 to Barbee discloses a quick-disconnect coupling for affixing tools like an earth-moving bucket or excavator to a powered arm. U.S. Pat. No. 5,382,110 to Perotto et al. discloses a quick coupling device adapted for attaching mining and construction tools to a boom of a carrier. Applicant incorporates by reference and reserves the right to distinguish the U.S. Patents cited herein from the present invention.

All the aforementioned hinges, however, are limited to specific components or devices that minimize their flexibility and usefulness. Thus, there is a need for a quick coupling device or hinge that can accommodate many uses and provides the flexibility of multi-dimensional configuration.

The coupling device or hinge disclosed herein may also be a component of an outdoor cooking apparatus. Outdoor cooking grills are well known and popular. There have been several attempts to provide cooking grills with multiple cooking platforms or rotating designs to improve the experience and flexibility of cooking outdoors. For example, U.S. Pat. No. 5,287,844 to Fieber discloses a campfire grill for cooking over an open fire with interchangeable cooking implements that can be adjusted to a desired height above a campfire. U.S. Pat. No. 5,819,718 to Leiser discloses a portable barbeque grill having a grill grate that can be adjusted vertically, horizontally, or rotated above or away from a heat source. Similarly, U.S. Pat. No. 5,862,742 to Bjerg discloses cantilevered cooking grills for campfires with multiple cooking arms.

The aforementioned outdoor barbecue grills and others in the prior art typically offer limited features. Therefore, there is a further need for an outdoor cooking apparatus that combines multiple cooking supports or components, rotatable and vertical movement over a heat source area, multiple cooking surfaces, and the ability to easily add or remove cooking supports or components without tools.

### BRIEF SUMMARY OF THE INVENTION

The present invention provides a C-shaped quick coupling device or hinge comprising a vertical support brace and horizontal upper and lower brackets, wherein the upper bracket comprises a curve-shaped hook end and the lower bracket comprises an oval or semi oval-shaped end and other curves. The upper bracket end is adapted to engage a collar, which either can be operably connected to or integrated within a vertically oriented spine. The spine essentially comprises a smooth or circumferentially grooved rod of a certain or adjustable length. Preferably, the collar comprises a split collar adapted for user-adjustable positioning along a select vertical length of the spine. When the collar is so positioned, the upper bracket of the device comprising the hook end engages and rests upon the collar and the lower bracket comprising the oval-shaped end rests upon the spine allowing the device to rotate around a vertical axis of the spine. The inner radial circumference of both the hook and oval-shaped ends are slightly larger than the outside circumference of the spine so the hook and oval-shaped ends partially encircle the spine when engaged with the collar and spine. The notched embodiment of the spine does not require a collar and allows the hook end to engage a circumferentially grooved or notched section of the spine and the oval end to engage the larger radius of the spine.

The device or hinge may further be adapted as an attached or attachable component of a support that when engaged with the collar and spine allows the attached component to also rotate around a vertical axis of the spine. In an embodiment, the support may comprise a cooking surface that when positioned along a vertical axis of the spine, allows the support and surface to be adjusted vertically or laterally relative to a heat source.

The device or hinge also may be adapted to receive or operably connect to a component, thereby mechanically or frictionally securing the component to the hinge. In such an embodiment, different components for various uses can be attached to the device or hinge.

The present invention also provides an outdoor cooking grill or apparatus comprising a heat source area, at lease one vertically oriented spine, at least one cooking support operably connected to a spine and adapted for rotatable and vertical movement above the heat source area, and a quick-release mechanism attached or attachable to the cooking support that allows a user to easily, quickly and efficiently add or remove the cooking support from the spine without hand tools. The cooking support further comprises a plurality of cooking surfaces to increase the total cooking surface of the apparatus or types of cooking surfaces.

The heat source area may define a perimeter that impedes horizontal movement of the source while allowing heat to vertically rise and warm the cooking surface or surfaces. The spine is adapted to engage a cooking support and hold it in place along a vertical length of the spine. The coupling device or hinge is adapted to engage the spine and/or the collar and allows a user to add or remove cooking supports and surfaces without tools. The hinge also allows the cooking support and surface to rotate around the vertical axis of the spine allowing the user to rotate the cooking support and surface over or away from the heat source.

### DESCRIPTION OF THE DRAWINGS

The invention can be better understood by reference to the following drawings, wherein:

FIG. 1 is an embodiment of a coupling device or hinge.

FIG. 2 is another embodiment of a coupling device or hinge.

FIG. 3 is a further embodiment of a coupling device or hinge.

FIG. 4 is another embodiment of a coupling device or hinge.

FIG. 5 is another embodiment of a coupling device or hinge.

FIG. 6 is another embodiment of a coupling device or hinge.

FIG. 7 is another embodiment of a coupling device or hinge.

FIG. 8 is an embodiment of a spine.

FIG. 9 is another embodiment of a spine.

FIG. 10 is an embodiment of a collar.

FIG. 11 is an embodiment of a heat source area and spine.

FIG. 12 is an embodiment of an outdoor cooking apparatus.

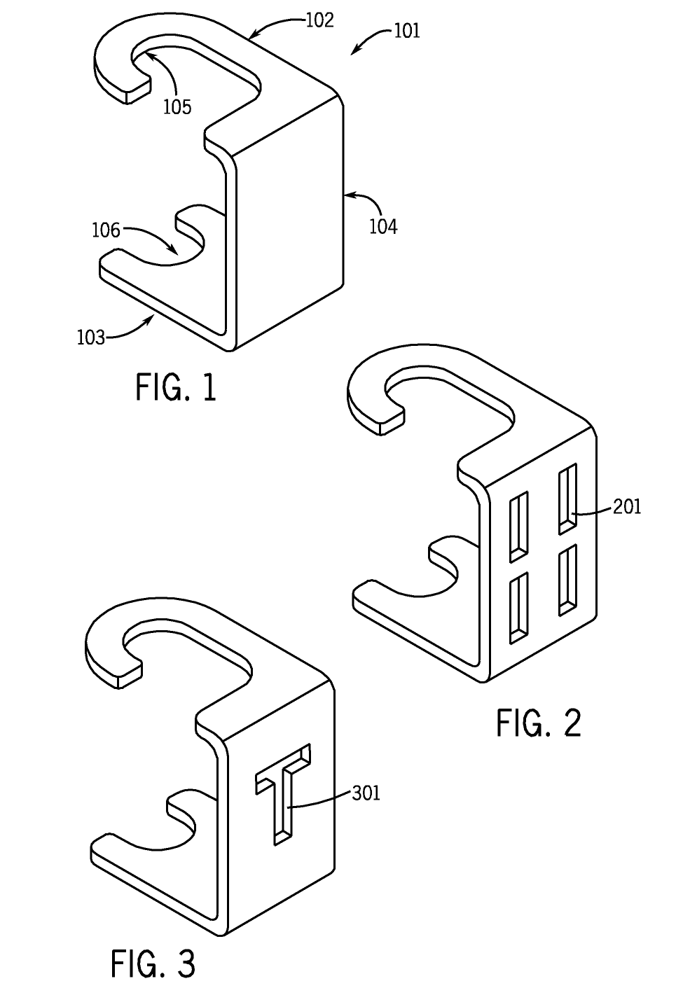

### DETAILED DESCRIPTION

In the following detailed description, the accompanying drawings show by way of illustration specific embodiments or examples. These embodiments may be combined, other embodiments may be utilized, and structural, logical, and procedural changes may be made without departing from the spirit and scope of the present invention. The following detailed description is, therefore, not to be taken in a limiting sense, and the scope of the present invention is defined by the appended claims and their equivalents.

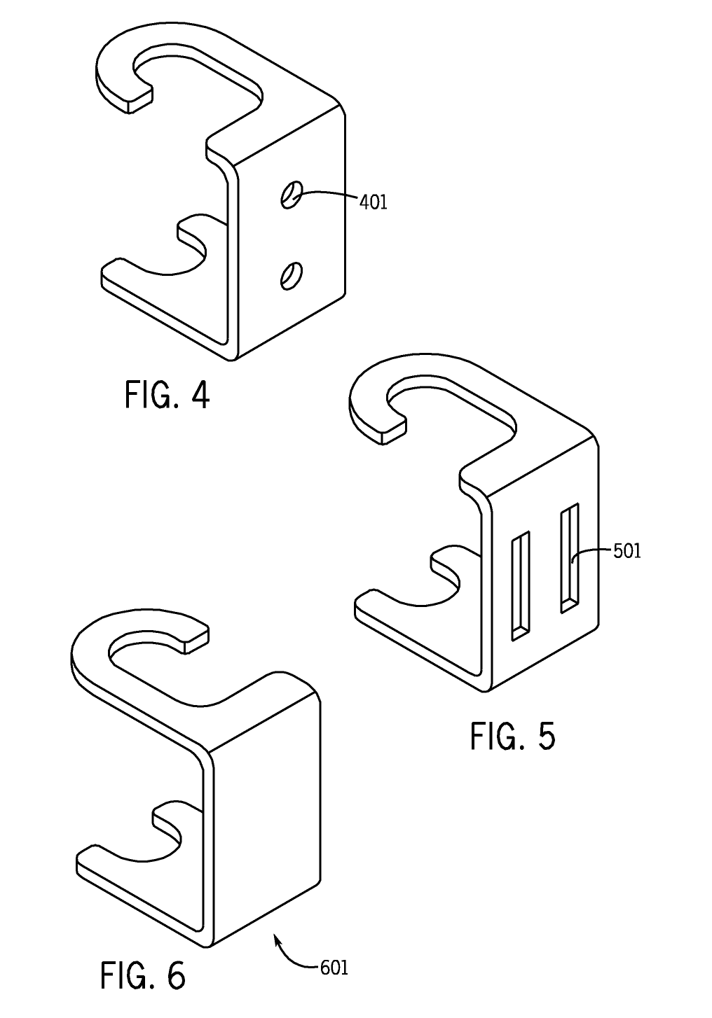

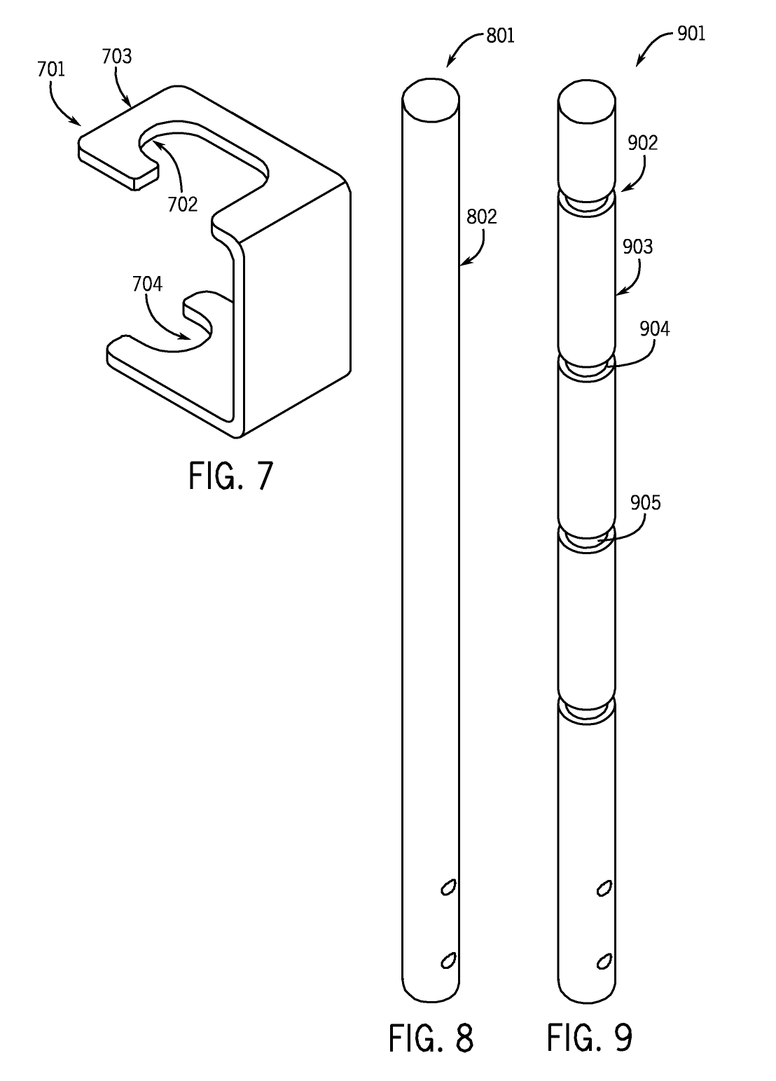

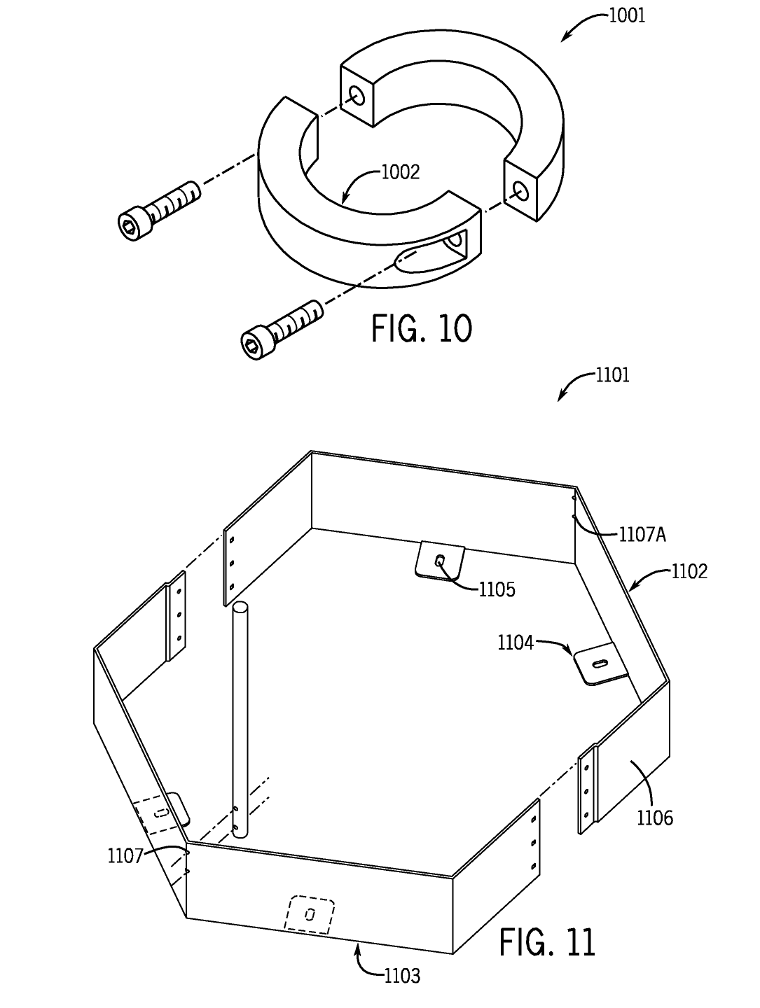

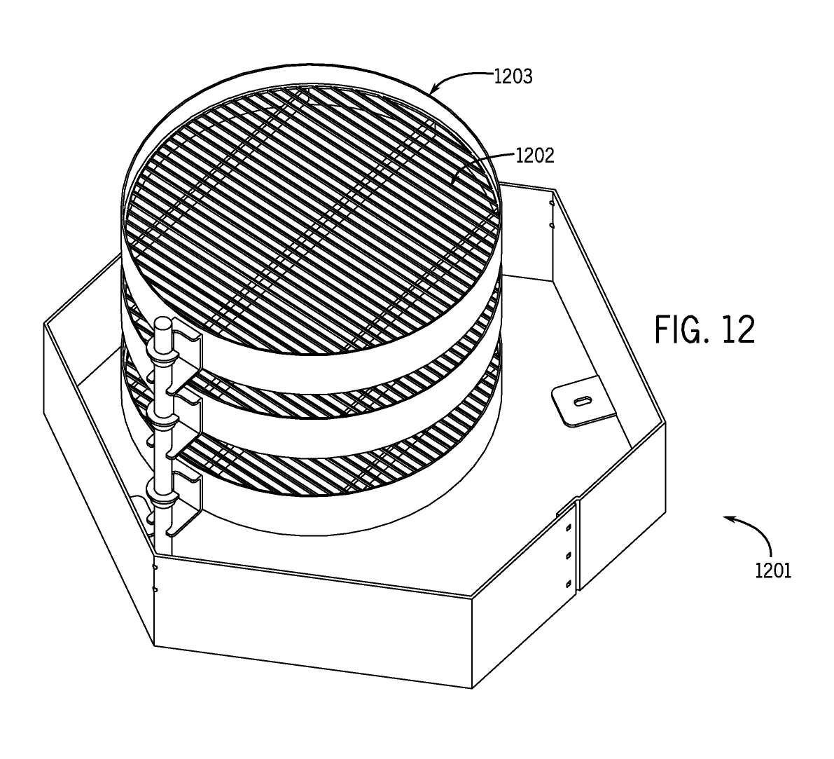

An embodiment of the device or apparatus comprises steel, although other rigid materials like plastic, wood or other metals like cast iron may be suitable. An embodiment of the coupling device or hinge comprises a C-shaped article 101 601 701 further comprising upper 102 and lower horizontal 103 brackets integrated with a vertical support brace 104, wherein the two horizontal brackets are adapted to engage a collar 1001 mounted on a spine 801 or a flange 902 incorporated in a spine 901. In these embodiments, the upper bracket comprises a curved hook end 105 and the lower bracket comprises an oval or semi oval-shaped end 106. In another embodiment, the curved, hook end 702 includes a more angular upper bracket 703. In addition, as shown in FIGS. 2-5, the vertical support brace of the coupling device or hinge may be adapted to include various mechanisms to connect the hinge to a component. Such mechanisms may include a slot or plurality of slots 201 501 to accommodate hooks, a keyhole connection 301 to accommodate a corresponding male key, or holes 401 to allow a component to bolt to the coupling device. The inner radial circumference of both the hook 105 and oval 106 are slightly larger than the outside circumference of the spine 802 903 904 so the hook and oval can partially encircle the spine when engaged with the spine.

Another embodiment includes a spine further comprising a plurality of notches or circumferential grooves 901, which are adapted to receive the hook end 105 702 of the coupling device 101 701 in a manner functionally equivalent to the aforementioned collar 1001. In this embodiment, the semi oval-shaped end 106 704 frictionally engages the larger diameter 903 of the spine 901.

The coupling device or hinge engages the spine by resting upon a collar 1001 attachable to the spine 801 or the flange 902 created by the circumferential groove 905. In one embodiment, the collar comprises a split collar with an adjustable inner circumference 1001. Said inner circumference 1002 can be adjusted to slightly larger than the outside circumference of the spine 802 so the collar can slip over or around the spine. The collar 1001 is adapted to frictionally engage the spine 802, for example by tightening, thereby allowing the user to position the collar along a length of the spine of the user's choosing. In another embodiment, the user may employ a plurality of collars. In another embodiment, the collar comprises a sleeve with an inner diameter slightly larger than the outer diameter of the spine so the sleeve can slip over the spine and rest upon a side, the ground, or the collar of a sleeve placed below. In this embodiment, the user may employ sleeves of different lengths to adjust the relative height of the cooking supports above the heat source.

The spine 801 901 is essentially a rod comprising metal, like steel, or other suitable materials. Those skilled in the art will appreciate the spine might comprise plastic, wood, or other rigid material. For example, an embodiment might include a plastic spine, collar, couple or hinge, including any adapted component attachable to the hinge. Another embodiment of the spine may comprise at least one integrated collar positioned along an axis perpendicular to the vertical axis of the spine. A further embodiment may comprise a circumferentially grooved rod 901 wherein the circumference of the grooved section 904 is smaller than an adapted circumference of the hook end 105 702.

In the aforementioned embodiments, the hook end of the coupling device or hinge rests upon the collar or flange formed by the circumferential groove and the oval-shaped end is frictionally engaged with the spine. When so engaged with the spine, the device or hinge is adapted to rotate around a vertical axis of the spine. Thus, any component attached to the device or hinge can be rotated around a vertical axis of the spine or positioned along a length of the spine.

When utilized as a component of an outdoor cooking apparatus 1201, the coupling device or hinge provides vertical and rotatable movement of a component or support 1203 attachable to the device or hinge in relationship to a heat source.

The heat source area may comprise a heat containment area or structure 1101 further comprising circular, rectangular or hexagon 1101 configurations comprising identical sections 1102 1103 that can be assembled and disassembled to make the cooking apparatus portable. Those skilled in the art will appreciate that other shapes may be suitable and equivalent to the aforementioned configurations. An embodiment of the heat containment structure 1101 includes at least one anchor 1104, preferably a plurality of anchors adapted to accommodate a stake or nail in an opening 1105 through the anchor and into the ground to secure the heat containment structure to the ground. Another embodiment of the heat containment structure comprises an overhang on the top side of the structure defining a circular opening. A further embodiment of the heat containment structure comprises a partially enclosed bottom and support legs.

The heat containment structure, regardless of the shape or configuration, might define a raised perimeter 1106 confining a heat source. The raised perimeter also impedes the heat source, as in the case of loose wood or charcoal, from falling or moving outside the perimeter. The heat source might include an electrical source, burning wood or charcoal, or ignited fossil fuel like propane gas. Those skilled in the art will appreciate that other heat sources may be suitable and equivalent to practice the invention disclosed herein.

The heat containment structure 1101 is further adapted to mount and support 1107 a spine 801 901 and may be configured to mount the spine at a plurality of locations 1107 1107a on the structure. In the embodiment of a cooking apparatus, the spine is essentially a metal rod, like steel, or other suitable material. In one embodiment, the structure includes a plurality of spine mounts, each adapted to receive, retain, and support a spine.

As discussed before, the hook of the coupling device 101 701 may rest upon a collar 1001 eight engaged with the spine. When the hook is so positioned, the oval end of the device rests upon and is frictionally engaged with the spine. When the hook and oval ends are so engaged, any component operably connected to the coupling device, like, by way of non-limiting example only, a support 1203 for a cooking surface 1202, can be easily positioned at a desired height along the spine by adjusting the position of the collar. Such a cooking support 1203 also can be easily rotated around a vertical axis of the spine allowing the support and surface to rotate away from and over the heat source.

An embodiment of the cooking support 1203 includes a plurality of such supports separately attachable or connectable to the spine. The cooking support may comprise a ring 1203, which is attached or attachable to the coupling hinge. The ring of the cooking support may be further adapted to comprise an inner-ring comprising a lip that traverses the inner circumference of the ring, a plurality of smaller lips equally dispersed within the circumference of the ring, or a support bar or plurality of bars traversing the inner diameter of the ring upon which a cooking surface 1202 may be securely placed within the ring 1203. In one embodiment, multiple cooking supports can be adapted to vertically funnel and partially trap smoke and heat to speed cooking and/or create a smoking effect. In this embodiment, the cooking support at the top of the smoking column may be adapted to accommodate a lid to trap heat and/or smoke to create a consistent cooking temperature like an oven. By way of non-limiting example only, suitable cooking surfaces include a grate, a wok, a griddle, a skillet, rotisserie, an arm comprising a hook, and/or a Dutch oven.

Embodiments of the cooking apparatus may include other features like a ring or tube that traverses the circumference of the heat containment structure and adapted as a foot rest. The heat containment structure may also include a wind deflector or shield, and/or air intakes carved out of the structure to channel air towards the heat source.

It is to be understood that the above description is intended to be illustrative and not restrictive. For example, the above-described embodiments and variations may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A coupling device comprising:
a. rigid material;
b. a horizontally oriented upper bracket, wherein the upper bracket comprises a curved, semi-oval hook end;
c. a vertically oriented support brace; and
d. a horizontally oriented lower bracket, wherein the lower bracket comprises a curved, semi-oval end.

2. The coupling device of claim 1 further comprising at least one slot to accommodate a hook.

3. The coupling device of claim 1 further comprising at least one keyhole to accommodate a corresponding male key.

4. The coupling device of claim 1 further comprising at least one hole to accommodate a bolt.

5. The coupling device of claim 1 further comprising:
a. A collar adapted to frictionally support the upper bracket; and
b. a spine, wherein the collar is adapted to fictionally connect to the spine.

6. The coupling device of claim 1, wherein the device is adapted to frictionally engage a circumferential groove on a spine.

7. The coupling device of claim 6, wherein the spine includes a plurality of circumferential grooves.

8. The coupling device of claim 1, wherein the device is a component of an outdoor cooking apparatus further comprising:
a. a heat source area;
b. a vertically oriented spine;
c. a collar adapted to frictionally connect to the spine and support the device or hinge; and
d. at least one cooking support adapted to be attached or attachable to the device or hinge and operably connected to the spine and further adapted for efficient attachment and detachment of the cooking support to and from the spine and also adapted for rotatable movement around a vertical axis of the spine and vertical movement up and down a vertical length of the spine to provide vertical and lateral movement of the cooking support over, near, or away from the heat source.

9. The outdoor cooking apparatus of claim 8, wherein the apparatus comprises metal, including steel or cast iron.

10. The outdoor cooking apparatus of claim 8, wherein the heat source area defines a perimeter.

11. The outdoor cooking apparatus of claim 10, wherein the perimeter defines a heat containment structure.

12. The outdoor cooking apparatus of claim 11, wherein the heat containment structure comprises a hexagon shape.

13. The outdoor cooking apparatus of claim 12, wherein the heat containment structure comprises at least one anchor comprising a longitudinal flange and an opening therein adapted to retain a stake to secure the heat containment structure to the ground.

14. The outdoor cooking apparatus of claim 12, wherein the spine is attachable to the heat containment structure.

15. The outdoor cooking apparatus of claim 12, wherein a plurality of spines are attachable to the heat containment structure.

16. The outdoor cooking apparatus of claim 8, wherein the spine is attachable to the ground.

17. The outdoor cooking apparatus of claim 16, wherein the spine includes a stake adapted to be embedded in the ground.

18. The outdoor cooking apparatus of claim 8, wherein the apparatus includes a plurality of collars.

19. The outdoor cooking apparatus of claim 8, wherein the at least one cooking support includes a plurality of cooking supports.

20. The outdoor cooking apparatus of claim 19, wherein the plurality of cooking supports further comprise a plurality of cooking surfaces.

21. The outdoor cooking apparatus of claim 20, wherein the plurality of cooking surfaces include grates.
